(19) United States
(12) Patent Application Publication
(10) Pub. No.: US 2024/0309486 A1
(43) Pub. Date: Sep. 19, 2024

(54) SYSTEMS AND METHODS OF THERMOCHEMICALLY REDUCING METALLIC ELEMENTS USING THERMAL SHOCK

(71) Applicant: The Johns Hopkins University, Baltimore, MD (US)

(72) Inventors: Timothy J. Montalbano, Fulton, MD (US); Scott M. Holdren, Owings Mills, MD (US)

(73) Assignee: The Johns Hopkins University, Baltimore, MD (US)

(21) Appl. No.: 18/591,714

(22) Filed: Feb. 29, 2024

Related U.S. Application Data
(60) Provisional application No. 63/490,289, filed on Mar. 15, 2023.

(51) Int. Cl. C22B 7/00; C22B 1/248; C22B 4/08

(52) U.S. Cl. CPC C22B 7/001; C22B 1/248; C22B 4/08

(57) ABSTRACT

A system includes a chamber comprising one or more openings and filled with an inert or reducing gas. The system includes a conductive material, at least one set of electrodes coupled to the conductive material, and a power supply configured to apply a voltage across the at least one set of electrodes to allow current to flow through and heat the conductive material. The system is configured to thermochemically reduce particulates by heating the particulates that are in electrical and/or thermal contact with the conductive material.

### CROSS-REFERENCE TO RELATED APPLICATIONS

The present application claims priority to and filing benefit of U.S. Provisional Patent Application No. 63/490,289 filed on Mar. 15, 2023, which is incorporated herein by reference in its entirety.

### BACKGROUND

### Field

Embodiments relate to systems and methods of recycling metals, for example, thermochemically reducing metals in electronic waste.

### Background

Rare earth elements (REEs) are critical materials for electronics and clean technologies. Current methods of producing REEs include aqueous acid leaching and biphastic solvent extraction of mined materials. These methods are energy intensive and produce a large amount of hazardous waste. An alternative source for REEs is the ubiquitous and growing amount of electronic waste from used computers, tablets, and mobile devices. An efficient method of extracting REEs from electronic waste can provide a profitable means for recycling these materials.

### SUMMARY

Disclosed herein are systems and methods for concentrating metals in particulates, such as electronic waste, through thermochemical reduction of the particulates in an inert and/or reducing environment.

In one aspect, a method includes receiving particulates in a chamber, such that the particulates are in electrical and/or thermal contact with a conductive material in the chamber. The method includes thermochemically reducing the particulates by heating the particulates in an inert or reducing environment by applying a voltage to at least one set of electrodes connected to the conductive material.

In another aspect, a system includes a chamber comprising one or more openings and filled with an inert or reducing gas. The system includes a conductive material, at least one set of electrodes coupled to the conductive material, and a power supply configured to apply a voltage across the at least one set of electrodes to allow current to flow through and heat the conductive material. The system is configured to thermochemically reduce particulates by heating the particulates that are in electrical and/or thermal contact with the conductive material.

In another aspect, a method includes loading particulates onto a sheet of material using a roller-based processing line, moving the sheet of material into a chamber, filling the chamber with an inert or reducing gas, and heating the particulates by thermal shock in an inert or reducing environment to form concentrated particulates.

### BRIEF DESCRIPTION OF THE DRAWINGS/FIGURES

The accompanying drawings, which are incorporated herein and form part of the specification, illustrate the present disclosure and, together with the description, further serve to explain the principles of the present disclosure and to enable those skilled in the relevant art(s) to make and use aspects described herein.

FIG. 1 illustrates a chamber, according to some aspects.

FIGS. 2A and 2B illustrate a roll-to-roll processing system, according to some aspects.

FIGS. 3 and 4 illustrate methods, according to some aspects.

The features of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements. Additionally, generally, the left-most digit(s) of a reference number identifies the drawing in which the reference number first appears. Unless otherwise indicated, the drawings provided throughout the disclosure should not be interpreted as to-scale drawings.

### DETAILED DESCRIPTION

The aspects described herein, and references in the specification to “one aspect,” “an aspect,” “an exemplary aspect,” “an example aspect,” etc., indicate that the aspects described can include a particular feature, structure, or characteristic, but every aspect may not necessarily include the particular feature, structure, or characteristic. Moreover, such phrases are not necessarily referring to the same aspect. Further, when a particular feature, structure, or characteristic is described in connection with an aspect, it is understood that it is within the knowledge of those skilled in the art to effect such feature, structure, or characteristic in connection with other aspects whether or not explicitly described.

Spatially relative terms, such as “beneath,” “below,” “lower,” “above,” “on,” “upper” and the like, can be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus can be otherwise oriented (rotated 90 degrees or at other orientations) and the spatially relative descriptors used herein can likewise be interpreted accordingly.

The terms “about,” “approximately,” or the like can be used herein indicates the value of a given quantity that can vary based on a particular technology. Based on the particular technology, the terms “about,” “approximately,” or the like can indicate a value of a given quantity that varies within, for example, 10-30% of the value (e.g., ±10%, ±20%, or ±30% of the value).

Aspects of the present disclosure can be implemented in hardware, firmware, software, or any combination thereof. Aspects of the disclosure can also be implemented as instructions stored on a computer-readable medium, which can be read and executed by one or more processors. A machine-readable medium can include any mechanism for storing or transmitting information in a form readable by a machine (e.g., a computing device). For example, a machine-readable medium can include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Furthermore, firmware, software, routines, and/or instructions can be described herein as performing certain actions. However, it should be appreciated that such descriptions are merely for convenience and that such actions result from computing devices, processors, controllers, or other devices executing the firmware, software, routines, instructions, etc. The term “machine-readable medium” can be interchangeable with similar terms, for example, “computer program product,” “computer-readable medium,” “non-transitory computer-readable medium,” or the like. The term “non-transitory” can be used herein to characterize one or more forms of computer readable media except for a transitory, propagating signal.

Disclosed herein are exemplary systems and methods for concentrating metals in particulates by thermochemical reduction of the particulates in an inert or reducing environment.

Particulates may comprise ground/milled electronic waste, bauxite residue, coal fly ash, or the like.

As used herein the term thermal shock process may refer to the rapid heating of a material above 1,500 C via Joule heating (i.e., resistive heating). In Joule heating, electrical energy can be converted to thermal energy as a current flows through a conductive material. The conductive material may be heated to a temperature above 1,500 C in millisecond or second timescales. Particulates in electrical and/or thermal contact with the conductive material can be simultaneously heated. The heating may cause thermochemical reduction of the particulates. Particulates do not need to be compressed and/or mixed with a conductive additive for efficient thermochemical reduction to occur. If a carbon containing material is used to perform the Joule heating, the process may be considered a carbothermal shock process.

A thermal shock process may be implemented in an inert or reducing environment. A reducing environment may comprise an environment in which oxidation is prevented by the absence of oxygen and other oxidizing gasses or elements. A reducing environment may also include actively reducing gases or elements that are readily oxidized. For example, carbon based materials may be used as reducing elements. An inert environment may comprise an environment containing an inert gas, such as argon. In some aspects an inert environment may also include a reducing element.

Metals, such as neodymium, lanthanum and scandium, can be extracted from thermochemically reduced particulates via acid digestion. Digestion may include soaking the particulates in acid, for example, sulfuric, nitric and/or perchloric acid. A higher concentration of metals may be extracted from the particulates after thermochemical reduction.

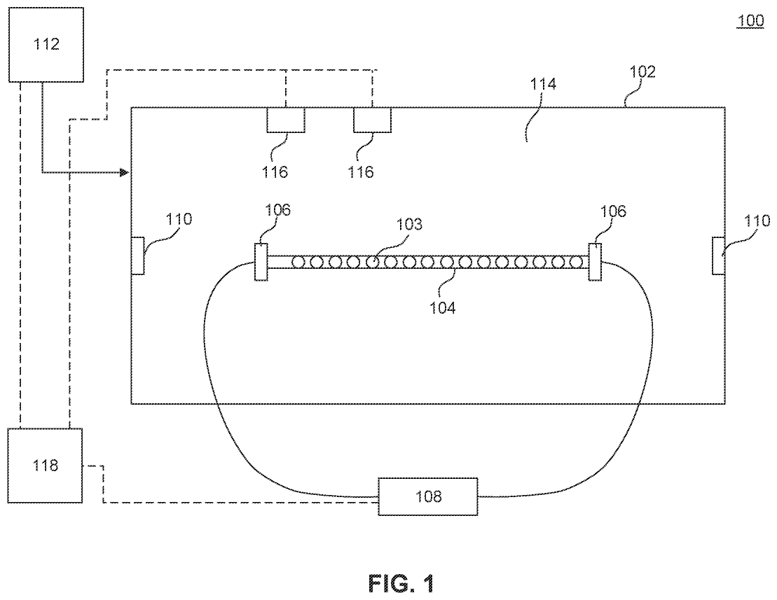

FIG. 1 shows a system 100, according to some aspects. For example, system 100 can be a carbothermal shock system. In one aspect, system 100 may include a chamber 102, a conductive material 104, one or more sets of electrodes 106, and a power supply 108.

In some aspects, chamber 102 contains one or more openings 110. Materials and/or system components, such as waste particulates 103 and conductive material 104, are moved into and out of chamber 102 through the one or more openings 110. Conductive material 104 may comprise a conductive felt, foil, mesh, or the like. In some aspects, conductive material 104 comprises carbon or tungsten. Gaps in conductive material 104, such as open spaces in a felt or foil, may contain particulates 103.

In some aspects, chamber 102 is configured for heating. Conductive material 104 may act as a heating element for chamber 102. For example, one or more sets of electrodes 106 may be connected to conductive material 104 inside of chamber 102. Power supply 108 may apply a voltage across one or more sets of electrodes 106, which produces a current in conductive material 104. In some aspects, power supply 108 is a DC power supply. In one aspect, as current flows through conductive material 104, conductive material 104 increases in temperature due to Joule heating (i.e., resistive heating). In some aspects, the heating occurs in a reducing environment.

In some aspects, a gas supply 112 supplies chamber 102 with gas 114 during heating. Gas 114 may comprise an inert gas, such as argon, or a reducing gas, such as hydrogen. Introducing an inert gas into chamber 102 reduces the amount of oxygen in the chamber during heating, thereby preventing further oxidation of particulates 103. In some aspects, chamber 102 is sealed during heating such that gas from the outside environment cannot enter chamber 102.

Conductive material 104 may directly or indirectly heat particulates 103. In some embodiments particulates 103 are directly heated through electrical and/or thermal contact with conductive material 104. In an alternative embodiment, conductive material 104 may heat particulates 103 via radiation. In both embodiments, particulates 103 may be uncompressed during heating.

System 100 may additionally include one or more sensors 116. One or more sensors 116 may include, as non-limiting examples, temperature sensors, oxygen sensors, current sensors, or the like. A temperature sensor, such as a spectrometer, may measure the temperature of particulates 103 and/or conductive material 104 during heating. Temperature measurements may ensure that particulates 103 reach a desired temperature. One or more oxygen sensors may measure the amount of oxygen in chamber 102 during heating to ensure that chamber 102 remains an inert/reducing environment. A current sensor may measure the amount of current flowing through conductive material 104. The amount of current flowing through a material is directly related to the amount of heat generated via Joule heating. Current measurements may ensure that the current is high enough to achieve the desired heating effect and/or low enough to avoid damage to conductive material 104 and power supply 108.

In some aspects, one or more sensors 116 may communicate with a control system 118. For example, control system 118 may receive temperature, current, and/or oxygen data from the one or more sensors 116. Control system 118 may use values obtained from the one or more sensors 116 to control operating parameters of system 100.

In some aspects, control system 118 may communicate with power supply 108 to control the amount of voltage and/or length of time voltage is applied to one or more sets of electrodes 106.

In some aspects, control system 118 may communicate with gas supply 112 to control the amount, timing, and/or rate of gas flow applied to chamber 102.

In some aspects, thermal shock systems, such a system 100, may be integrated into a roll-to-roll processing system. Such integration can allow for recycling of metals in waste material at an industrial scale.

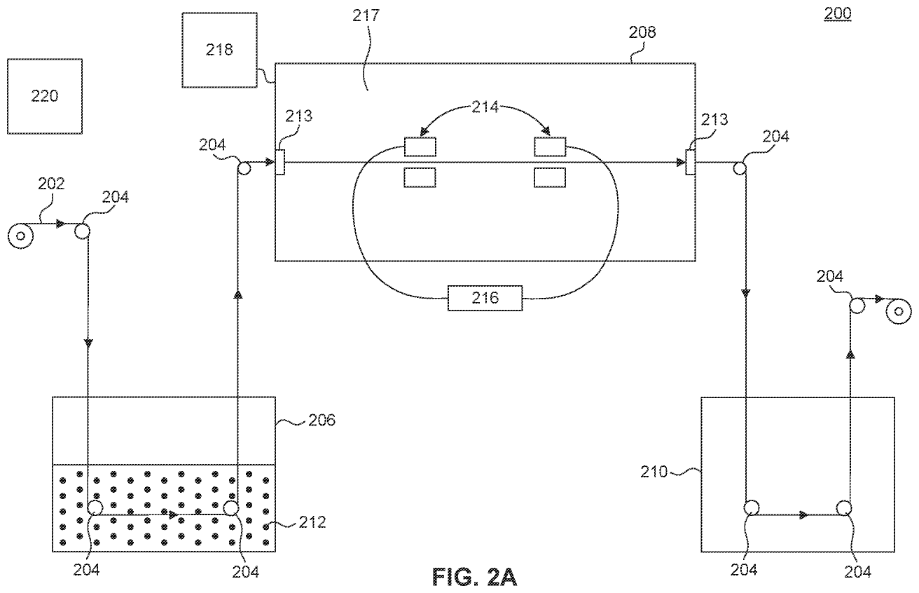

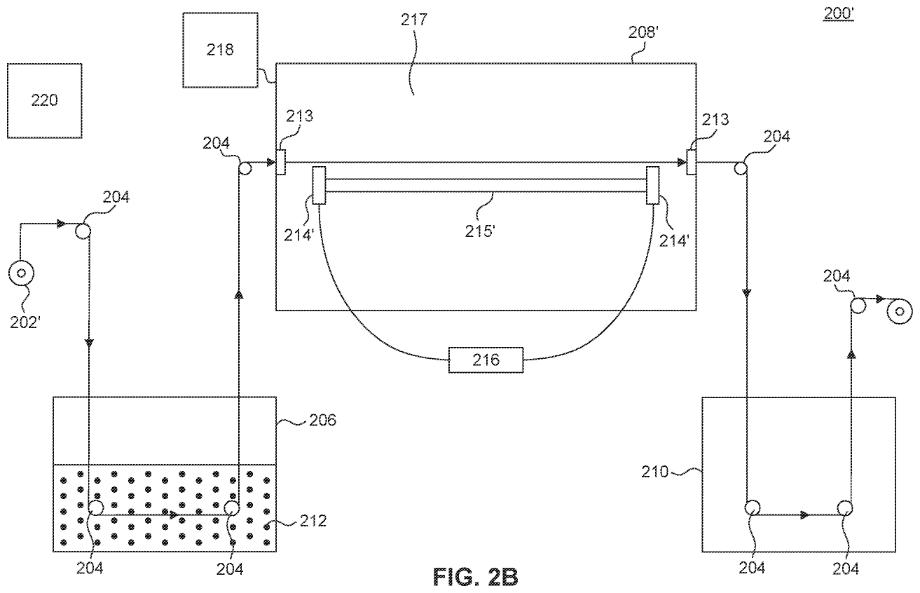

FIGS. 2A and 2B illustrate systems 200 and 200′, according to some aspects. For example, systems 200 and 200′ can be roll-to-roll processing systems. Roll-to-roll processing is a continuous process in which flexible materials are transported on rollers through processing machinery. Roll-to-roll processing systems 200 and 200′ may be used to concentrate metals, such as rare earth elements, in particulates through a thermal shock process.

FIG. 2A illustrates a roll-to-roll processing system 200, according to some aspects. Roll-to-roll processing system 200 may comprise a material 202, one or more rollers 204, a collection system 206, a heating chamber 208, and a removal system 210.

In some aspects, one or more rollers 204 may transport material 202 through system 200. Material 202 may comprise a thin, flexible material. In some aspects, material 202 may comprise a conductive material, such as carbon or tungsten. In some aspects, material 202 is configured to contain particulates 212. For example, material 202 may comprise a felt, foil, mesh, or the like.

In some aspects, material 202 undergoes a series of processing steps as material 202 moves through collection system 206, heating chamber 208, and removal system 210.

In some aspects, in collection system 206, material 202 collects particulates 212. Particulates 212 may be suspended in a solvent. The solvent may include an organic solvent, such as isopropyl alcohol or the like. As material 202 moves through the solvent, material 202 may collect particulates 212. In an alternative embodiment, collection system 206 may include a blower (not shown). The blower may stream dry particulates 212 onto and/or through material 202 with compressed air. In some aspects, particulates 212 are contained in material 202. For example, particulates 212 may be contained in open spaces of a mesh or foil.

In some aspects, one or more rollers 204 may move material 202 from collection system 206 to heating chamber 208. In heating chamber 208, particulates 212 are heated in a reducing (i.e., low oxygen) environment. For example, particulates 212 may be heated by a thermal shock process. In some aspects, during heating, at least a portion of metal oxides in particulates 212 are converted to metals, thereby increasing the concentration of metals, such as rare earth elements, in particulates 212.

In some aspects, heating chamber 208 may include one or more openings 213 through which material 202 can enter and exit chamber 208. After material 202 enters chamber 208, it may be clamped by electrodes 214. Voltage supply 216 may apply a voltage across electrodes 214, which may cause a current to flow through material 202.

In some aspects, voltage supply 216 is a DC power supply. As current flows through material 202, material 202 rapidly heats due to Joule heating. Because particulates 212 are in electrical and/or thermal contact with material 202, particulates 212 can be heated simultaneously. In some aspects, particulates 212 are heated for less than about 10 seconds or less than about 15 seconds. In some aspects, particulates 212 may be heated for up to 1 minute. In some aspects, particulates 212 may be heated to a temperature less than about 2,000 C. In some aspects, particulates 212 may be heated to a temperature between about 2,000 C and about 3,000 C.

In some aspects, gas supply 218 may supply heating chamber 208 with a gas 217 during heating. Gas 217 may comprise an inert gas, such as helium, argon, or the like. Gas 217 may also comprise a reducing gas, such as hydrogen. In some aspects, heating chamber 208 may be sealed during heating, such that outside air cannot enter the chamber.

In some aspects, heating chamber 208 may include additional elements, as described in FIG. 1. For example, heating chamber 208 may include one or more sensors to measure temperature, oxygen, and/or current.

In some aspects, after heating, one or more rollers 204 may move material 202 from heating chamber 208 to removal system 210. Removal system 210 may include a digestive acid for extracting particulates 212 from material 202. The digestive acid may comprise sulfuric acid, nitric acid, perchloric acid, or a combination thereof. In some aspects, the digestive acid may selectively digest particulates 212 without damaging material 202. In another example, removal system 210 may include a filtration system.

In some aspects, control system 220 may automate roll-to-roll processing system 200. Control system 220 may include a series of sensors and controllers for moving material 202 through roll-to-roll processing system 200. For example, control system 220 may include, as non-limiting examples, tension controls, vision systems, winding systems, speed controls (e.g., idler rollers), or the like. Control system 220 may also control elements of heating chamber 208. For example, control system 220 may control voltage supply 216 (i.e., length of time and amount of power applied to one or more sets of electrodes 214) and gas supply 218 (i.e., timing and amount of gas introduced into chamber 208). Control system 220 may receive data from one or more sensors in roll-to-roll processing system 200. In some aspects, control system 220 may alter operating parameters of roll-to-roll processing system 200 based on data collected from the one or more sensors.

FIG. 2B illustrates a roll-to-roll processing system 200′, according to some aspects. Roll-to-roll processing system 200′ can implement an alternative heating chamber 208′. Commonly numbered elements between FIG. 2A and FIG. 2B may have substantially the same function. Such elements may include, among others, one or more rollers 204, collection system 206, removal system 210, particulates 212, and control system 220.

In some aspects, in roll-to-roll processing system 200′, one or more rollers 204 may transport material 202′ through collection system 206, heating chamber 208′, and removal system 210. Material 202′ may comprise similar structure and function to material 202. However, because current is not applied to material 202′, material 202′ may include a wider range of materials. For example, in addition to conductive materials, material 202′ may include insulating materials.

In some aspects, after collecting particulates 212 in collection system 206 one or more rollers 204 may move material 202′ into heating chamber 208′. Heating chamber 208′ may include one or more openings 213 through which material 202′ can enter and exit the chamber.

In some aspects, in heating chamber 208′, particulates 212 are not in contact with a heating element. For example, one or more rollers 204 may move material 202′ containing particulates 212 above, below and/or adjacent to a heating element.

In some aspects, a heating element may include a conductive material capable of Joule heating. For example, chamber 208′ can include a conductive material 215′. Conductive material 215′ may comprise a carbon felt or foil, a tungsten filament, a nichrome wire, a conductive sheet, or the like.

In some aspects, conductive material 215′ is in electrical contact with one or more sets of electrodes 214′. A voltage supply 216 may supply a voltage across one or more sets of electrodes 214′, thereby causing current to flow through conductive material 215′. As current flows through conductive material 215′, conductive material 215′ heats via Joule heating (i.e., resistive heating).

In some aspects, gas supply 218 may supply gas 217 to heating chamber 208′. Gas 217 may comprise an inert gas, such as argon, or a reducing gas, such as hydrogen. Conductive material 215′ may heat gas 217, and therefore particulates 212, via radiation. In one example, particulates 212 are uncompressed during the heating.

In some aspects, material 202′ is stationary during the heating. In additional aspects, one or more rollers 204 move material 202′ through heating chamber 208′ during the heating.

In some aspects, particulates 212 may be heated to a temperature less than about 2,000 C. In some aspects, particulates 212 may be heated to a temperature between about 2,000 C and about 3,000 C. The particulates may be heated for less than about 15 seconds. In some aspects, the particulates may be heated for up to about 1 minute.

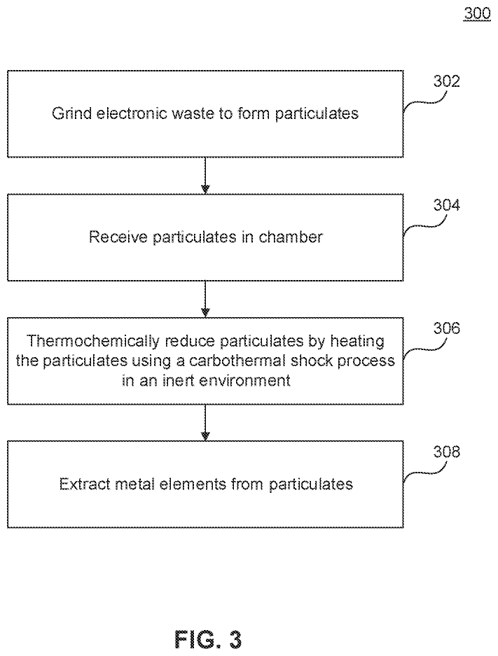

FIG. 3 shows a method 300, according to some aspects. For example, method 300 can be for extracting metals, such as rare earth elements, from waste material. Method 300 may comprise steps 302, 304, 306, and 308.

In some aspects, step 302 can comprise processing waste material to form particulates. In some aspects, waste material may contain metals or metal oxides. For example, waste material may comprise disused electronics (e.g., computers, tablets, and/or mobile devices), coal fly ash, bauxite residue, or the like. Processing may include grinding and/or pulverizing waste material into particulates. In some aspects, an average particulate may comprise a diameter less than or equal to about 100 micrometers.

In some aspects, step 304 can comprise receiving the particulates into a chamber. In some aspects, the particulates can be in electrical and/or thermal contact with a conductive material in the chamber. For example, the particulates may be contained in a conductive mesh, felt, or foil. In some aspects, the conductive material may include a carbon or tungsten material. The particulates may be moved into the chamber through one or more openings in the chamber.

In some aspects, step 306 can comprise heating the particulates in an inert and/or reducing environment. Heating the particulates may result in a thermochemical reduction of the particulates. The particulates may be uncompressed during the heating. In some aspects, the inert environment may comprise a chamber filled with an inert gas, such as argon, or a reducing gas, such as hydrogen.

In some aspects, the heating may comprise a thermal shock process, such as a carbothermal shock process. For example, a voltage may be applied to a set of electrodes electrically connected to a conductive material in the chamber. Voltage applied to the electrodes can cause a current to flow through the conductive material, resulting in Joule heating. In some aspects, particles in electrical/thermal contact with the conductive material can be heated as the conductive material is heated. In an alternative embodiment, the particulates may be heated through radiative heat transfer. For example, the conductive material may act as a heating element that radiates heat to particulates that are close to the heating element.

In some aspects, the heating includes a first phase and a second phase. During the first phase, the particulates may be preheated to remove water and/or convert part of the material to gas (e.g., carbon dioxide). Converting material to gas during the first phase reduces outgassing during the second phase. During the second phase, the particulates may be heated at a higher temperature to thermochemically reduce oxides (e.g., metal oxides) in the particulates. Thermochemical reduction results in a higher concentration of pure metals.

In some aspects, the heating may be completed within approximately 10 seconds or within approximately 15 seconds. In additional embodiments, the heating may be completed within approximately 1 minute. The heating time may be influenced by the amount of current flowing through the conductive material, or by the size of the conductive material. A faster heating time may reduce a total amount of energy required to heat the particulates. The heating may occur at a temperature at or below about 2,000 C. The heating may occur at a temperature at or below about 3,000 C.

In some aspects, step 308 can comprise extracting metal elements from the thermochemically reduced particulates. In some aspects, metals are extracted by acid digestion. The acid may comprise sulfuric acid, nitric acid, perchloric acid, or the like. Metals may be extracted from thermochemically reduced particulates using a lower (e.g., low molarity) concentration of acid. For example, measurable yields of rare earth metals may be produced by digestion with 0.01 M HNO₃. In some aspects, metals may be extracted from thermochemically reduced particulates through filtration methods.

The method steps of FIG. 3 can be performed in any conceivable order and it is not required that all steps be performed. Moreover, the method steps of FIG. 3 described above merely reflect an example of steps and are not limiting. That is, further method steps and functions are envisaged based aspects described in reference to FIGS. 1-2.

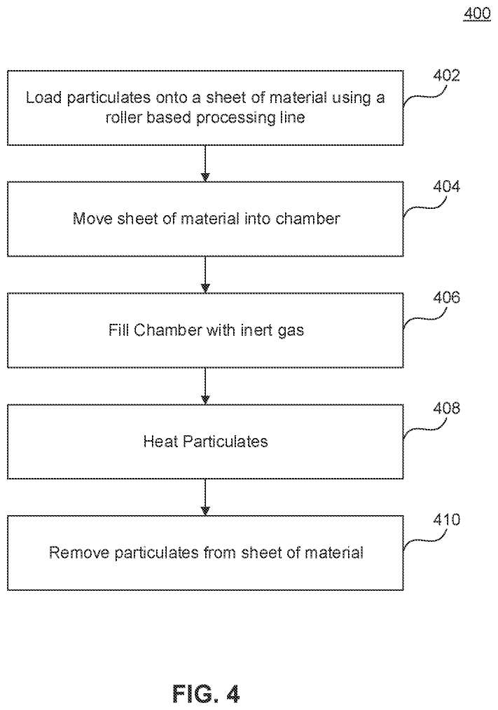

FIG. 4 shows a method 400, according to some aspects. For example, method 400 can be used for concentrating and extracting metals, such as rare earth elements, from particulates, according to some aspects. Method 400 may be implemented by a roll-to-roll processing system, such as system 200 or 200′. Method 400 includes steps 402, 404, 406, 408, and 410.

In some aspects, in step 402, waste particulates can be loaded onto a sheet of material using a roll-to-roll processing system. In some aspects, particulates can be loaded on the sheet of material by moving the sheet of material through a solution of particulates suspended in an organic solvent, such as isopropyl alcohol or the like. As the sheet of material moves through the solvent, the sheet of material may collect particulates. In an alternative embodiment, a blower may stream dry particulates onto and/or through the sheet of material with compressed air.

In some aspects, the sheet of material can comprise a conductive mesh or foil (e.g., carbon felt, carbon foil, and/or tungsten foil) capable of Joule heating. In additional embodiments, sheet of material comprises an insulator. The sheet of material may be chosen to withstand temperatures up to about 2,000 C and/or keep its structural integrity when submersed in acid. In some aspects, when the sheet of material is a mesh or foil, particulates are contained in open spaces in the mesh or foil.

In some aspects, in step 404, the sheet of material can be moved into a chamber. In some aspects, a series of rollers may move the sheet of material into the chamber through one or more opening in the chamber. The chamber may comprise a heating chamber, as described in FIGS. 1, 2A, and 2B.

In some aspects, in step 406, the chamber is filled with an inert or reducing gas. An inert gas may include argon or the like. A reducing gas may include hydrogen. In some aspects, existing gas in the chamber may be purged as the chamber is filled with an inert gas, like argon, or a reducing gas, like hydrogen. In some aspects, filling the chamber with an inert and/or reducing gas creates a reducing (i.e., low oxygen) environment.

In some aspects, in step 408, the particulates can be heated by a thermal shock process, such as a carbothermal shock process, to form thermochemically reduced particulates. A thermal shock process is described in step 306 of method 300. The particulates may be uncompressed during the heating. In some embodiments, the waste particulates are stationary as they are heated. In additional embodiments, the waste particulates are moved through the chamber as they are heated. The heating time may be influenced by the amount of current flowing through a conductive material and/or the size of the conductive material. In some aspects, the heating is completed within approximately 10 seconds or within approximately 15 seconds. The heating may occur at a temperature at or below about 2,000 C. In additional embodiments, the heating may occur at a temperature at or below about 3,000 C.

In some aspects, in step 410, thermochemically reduced particulates can be removed from the sheet of material. A system of rollers may move the material into a particulate collection system. The particulate collection system may dissolve the particulates in a digestive acid, such as sulfuric acid, nitric acid, perchloric acid, or a combination thereof.

In some aspects, the method steps of FIG. 4 are automated. For example, an automation system may include, as non-limiting examples, tension controls, vision systems, winding systems, and speed controls (e.g., idler rollers) to control the speed and tension of a material as it moves through a roll-to-roll processing system. An automation system can also control parameters relating to the heating in step 408, such as voltage supplied to electrodes and gas supplied to a chamber.

The method steps of FIG. 4 can be performed in any conceivable order and it is not required that all steps be performed. Moreover, the method steps of FIG. 4 described above merely reflect an example of steps and are not limiting. That is, further method steps and functions are envisaged based aspects described in reference to FIGS. 1-3.

It is to be appreciated that the Detailed Description section, and not the Summary and Abstract sections, is intended to be used to interpret the claims. The Summary and Abstract sections may set forth one or more but not all exemplary embodiments as contemplated by the inventor(s), and thus, are not intended to limit the embodiments and the appended claims in any way.

The embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the embodiments that others can, by applying knowledge within the skill of the art, readily modify and/or adapt for various applications such specific embodiments, without undue experimentation, without departing from the general concept of the embodiments. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the embodiments should not be limited by any of the above-described exemplary embodiments, but should be defined only in accordance with the following claims and their equivalents.

What is claimed is:

1. A method comprising:
receiving particulates in a chamber, such that the particulates are in electrical and/or thermal contact with a conductive material in the chamber; and
thermochemically reducing the particulates by heating the particulates in an inert or reducing environment by applying a voltage to at least one set of electrodes connected to the conductive material.

2. The method of claim 1, further comprising grinding electronic waste to form the particulates.

3. The method of claim 1, wherein an average diameter of the particulates comprises a diameter less than or equal to about 100 microns.

4. The method of claim 1, further comprising extracting rare earth elements from thermochemically reduced particulates using an acid.

5. The method of claim 1, wherein the particulates are uncompressed during the thermochemically reducing.

6. The method of claim 1, wherein the thermochemically reducing is completed within approximately 15 seconds.

7. The method of claim 1, wherein the thermochemically reducing occurs at a temperature at or below about 2,000 C.

8. A system comprising:
a chamber comprising one or more openings and filled with an inert or reducing gas;
a conductive material;
at least one set of electrodes coupled to the conductive material; and
a power supply configured to apply a voltage across the at least one set of electrodes to allow current to flow through and heat the conductive material,
wherein the system is configured to thermochemically reduce particulates by heating the particulates that are in electrical and/or thermal contact with the conductive material.

9. The system of claim 8, further comprising one or more sensors configured to measure temperature, current, and/or an amount of oxygen in the chamber.

10. The system of claim 8, wherein the conductive material comprises a carbon felt, a carbon foil, and/or a tungsten foil.

11. The system of claim 8, further comprising:
a roller-based processing line configured to move waste particulates into and out of the chamber through the one or more openings.

12. The system of claim 8, wherein the particulates are heated for about 15 seconds.

13. The system of claim 8, wherein the particulates are heated at a temperature at or below approximately 2,000 C.

14. A method comprising:
loading particulates onto a sheet of material using a roller-based processing line;
moving the sheet of material into a chamber;
filling the chamber with an inert or reducing gas; and
heating the particulates by thermal shock in an inert or reducing environment to form concentrated particulates.

15. The method of claim 14, further comprising automating the loading, moving, filling, and heating.

16. The method of claim 14, further comprising removing the concentrated particulates from the sheet of conductive material.

17. The method of claim 14, further comprising extracting rare earth elements from the concentrated particulates using an acid.

18. The method of claim 14, wherein the particulates are uncompressed during the heating.

19. The method of claim 14, wherein the heating is completed within about 15 seconds.

20. The method of claim 14, wherein the heating occurs at a temperature at or below approximately 2,000 C.
